(19) United States
(12) Patent Application Publication
(10) Pub. No.: US 2010/0201167 A1
(43) Pub. Date: Aug. 12, 2010

(54) VEHICLE SEAT ASSEMBLY HAVING A COMFORTABLE SEAT BACK PORTION

(75) Inventor: Stanislaw Andrzej Wieclawski, Hohenkammer (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/689,684

(22) Filed: Jan. 19, 2010

(30) Foreign Application Priority Data
Feb. 12, 2009 (DE) 10 2009 008 736.2

(51) Int. Cl. B60N 2/427; B60N 2/64

(52) U.S. Cl. 297/216.13; 297/284.3

(57) ABSTRACT

A vehicle seat assembly having a first back support member connectable to a seat bottom, a second back support member pivotally connected above the first back support member, the second back support member being configured to receive a headrest, and a biasing member connected to the second back support member. The second back support member pivots with respect to the first back support member though a defined range. The first biasing member is configured to urge the second back support member towards a forward end of the defined pivot range.

### CROSS-REFERENCE TO RELATED APPLICATIONS

This application claims foreign priority benefits under 35 U.S.C. §119(a)-(d) to DE 10 2009 008 736.2, filed Feb. 12, 2009, which is hereby incorporated by reference in its entirety.

### BACKGROUND OF THE INVENTION

1. Field of the Invention

Embodiments of the present invention relate to a vehicle seat assembly having a seat back having both an upper and a lower portion, the upper portion being pivotable with respect to the lower portion and being urged towards a forward portion of the vehicle seat assembly.

2. Background Art

In conventional vehicle seat assemblies, a backrest portion generally comprises a single member having an upper portion and a lower portion that are aligned with one another at a constant, non-adjustable angle. Because the size and shape of vehicle occupants varies widely, a non-adjustable seat back portion may provide more or less support to the upper back and shoulder areas of an occupant than is desired/needed for occupant comfort. For example, in some seat backs, the upper portion of the seat back may be angled with respect to the lower portion in a way that causes a vehicle occupant to bend forward. In other seat backs, the upper portion of the backrest may be angled towards the rear leaving the upper back and shoulders area of the seat occupant unsupported. It is desirable to provide a vehicle seat occupant with a vehicle seat having a seat back wherein the upper portion of the seat back can automatically adjust to accommodate the contour of the seat occupant's back and shoulders and thereby provide the seat occupant with improved comfort.

Another problem encountered by manufacturers of vehicle seat assemblies is how best to protect a seat occupant from the injuries associated with rear end collisions. Once such injury is whiplash which can occur as the head, neck and shoulder of a seat occupant is forced in a rearward direction during a rear end collision. An effective means of combating whiplash is to “catch” the head, neck and shoulders of a vehicle occupant as quickly as possible with the vehicle seat after a collision. It is therefore desirable for a vehicle seat assembly to provide a relatively small, constant distance between a vehicle occupant's head, neck and shoulders, on the one hand, and the upper portion of the backrest, on the other hand.

Embodiments of the invention disclosed herein address these and other problems.

### SUMMARY OF THE INVENTION

Various embodiments of a vehicle seat assembly are disclosed herein. In a first embodiment, the vehicle seat assembly comprises a first back support member that is configured for connection to a seat bottom. A second back support member is disposed above the first back support member and is pivotally connected thereto. The second back support member is configured to receive a headrest. A first biasing member is connected to the second back support member. In this first embodiment, the second back support member is configured to pivot with respect to the first back support member through a defined range having a forward end and a rearward end. The first biasing member is configured to urge the second back support member towards the forward end of the defined pivot range.

In an implementation of the first embodiment, the first biasing member is further connected to the first back support member.

In another implementation of the first embodiment, the first biasing member comprises a gas spring.

In another implementation of the first embodiment, the first biasing member has a spring constant of between approximately 100 Newtons per meter and 120 Newtons per meter. In a variation of this implementation, the first biasing member has a spring constant of approximately 110 Newtons per meter.

In another implementation of the first embodiment, the vehicle seat assembly further comprises a second biasing member that is connected to the second back support member. The second biasing member is configured to urge the second back support member towards the forward end of the defined pivot range.

In another implementation of the first embodiment, the vehicle seat assembly further comprises a damper that is configured to dampen pivotal motion of the second back support member as the second back support member pivots through the defined pivot range. In a variation of this implementation, the first biasing member is a gas spring having an integral damper. In an alternate variation, the damper comprises an hydraulic damper.

In another implementation of the first embodiment, the second back support member is configured to move the headrest approximately 200 mm as the second back support member pivots between the rearward end and the forward end of the defined sweep range.

In a second embodiment, the vehicle seat assembly comprises a first back support member that is configured for connection to a seat bottom. A second back support member is disposed above the first back support member and is pivotally connected thereto. The second back support member is configured to receive a headrest. A first biasing member is connected to the second back support member. A locking mechanism is connected to the second back support member. The locking mechanism is configured to move between a locked position and an unlocked position. In this second embodiment, the second back support member is configured to pivot with respect to the first back support member through a defined pivot range having a forward end and a rearward end. The first biasing member is configured to urge the second back support member towards the forward end of the defined pivot range. The locking mechanism is configured to inhibit pivotal movement of the second back support member with respect to the first back support member when the locking mechanism is in the locked position.

In an implementation of the second embodiment, the locking mechanism is configured to permit the second back support member to pivot with respect to the first back support member when forces acting on the second back support member exceed a predetermined threshold.

In another implementation of the second embodiment, the first biasing member is integral with the locking mechanism.

In another implementation of the second embodiment, the locking mechanism comprises a cylinder having a first chamber and a second chamber and a piston separating the first chamber from the second chamber wherein the piston defines a bore extending therethrough to permit a fluid to pass between the first chamber and the second chamber as the piston moves through the cylinder and a valve connected to the piston configured to selectively open and close the bore. In a variation of the implementation, the vehicle seat assembly further comprises a cable assembly that is connected to the locking mechanism and a trigger member that is connected to the cable assembly. The trigger member is configured to remotely actuate the locking mechanism via the cable assembly. In a further variation, the trigger member is configured for attachment to the seat bottom.

In another implementation of the second embodiment, the locking mechanism is configured to move to the locked position when the second back support member is disposed at any desired position within the defined pivot range.

In another implementation of the second embodiment, the first biasing member comprises a gas spring. In a variation of this implementation, the gas spring has an integral hydraulic damper.

In a third embodiment, the vehicle seat assembly comprises a seat bottom that is configured for attachment to a vehicle. A first back support member is pivotally connected to the seat bottom. A second back support member is disposed above the first back support member and is pivotally connected thereto. A headrest is connected to the second back support member. A gas spring is connected to the first back support member and the second back support member. The gas spring has an integral damper and an integral locking mechanism that is configured to move between a locked position and an unlocked position. In this third embodiment, the second back support member is configured to pivot with respect to the first back support member through a defined pivot range having a forward end and a rearward end. The gas spring is configured to urge the second back support member towards the forward end of the defined pivot range. The integral damper is configured to dampen pivotal movement of the second back support member as the second back support member pivots through the defined pivot range. The integral locking mechanism is configured to inhibit pivotal movement of the second back support member with respect to the first back support member when the locking mechanism is in the locked position.

### BRIEF DESCRIPTION OF THE DRAWINGS

The description herein makes reference to the accompanying drawings wherein like reference numerals refer to like parts throughout the several views, and in which:

FIG. 1 is a schematic view illustrating an embodiment of a vehicle seat assembly made in accordance with the teachings of the present invention having an upper back support member pivotally connected to a lower back support member and configured to pivot between a forward end and a rearward end of a pivot range and a biasing member configured to urge the upper back support member towards the forward end of the pivot range;

FIG. 2 is a rear view of the vehicle seat assembly illustrated in FIG. 1 equipped with a plurality of biasing members;

FIG. 3 is a schematic cross-sectional view illustrating an embodiment of a biasing member for use with the vehicle seat assembly of FIG. 1;

FIG. 4 is a schematic cross-sectional view illustrating an alternate embodiment of the biasing member illustrated in FIG. 3;

FIGS. 5 and 6 are schematic cross-sectional views illustrating yet another embodiment of the biasing member illustrated in FIG. 3 in an unlocked state (FIG. 5) and a locked state (FIG. 6);

FIGS. 7-9 illustrate the operation of the vehicle seat assembly of FIG. 1 equipped with the biasing member of FIGS. 5 and 6 while in the unlocked state;

FIGS. 10-12 are schematic side views illustrating operation of the vehicle seat assembly of FIG. 1 equipped with the biasing member of FIGS. 5 and 6 while in the locked state.

### DETAILED DESCRIPTION OF THE PREFERRED EMBODIMENT(S)

Detailed embodiments of the present invention are disclosed herein; however, it is to be understood that the disclosed embodiments are merely exemplary of the invention that may be embodied in various and alternative forms. The figures are not necessarily drawn to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Embodiments of the present invention include a vehicle seat assembly having a seat back comprising two components, a first or lower back support member and a second or upper back support member. The upper back support member is pivotally connected to the lower back support member and is constrained to pivot within a pivot range having a forward end (forward being determined with respect to the vehicle seat assembly) and a rearward end. The lower back support member can be connected to a seat bottom while the upper back support member can receive a headrest.

A biasing member is attached to the upper support member and is configured to urge the upper back support member toward the forward end of the pivot range. The biasing member may be any type of spring including, but not limited to, leaf springs, coil springs, clock springs and gas springs. With the biasing member urging the upper back support member towards the forward end of the pivot range, the vehicle seat assembly can provide the shoulders and upper back of a seat occupant with a consistent level of support and comfort regardless of his posture or physiology.

As a seat occupant stretches backward, he pushes against the upper back support member which, in turn, pushes against the biasing member which yields and flexes to accommodate the occupant's movement. As the occupant leans forward, the upper back support member pivots forward with him to provide a consistent level of support to his back and shoulders.

In addition to providing comfort and support, the pivotal movement of the upper back support member also ensures that there is a generally constant distance between the occupant's head and the headrest attached to the upper back support member. By providing a generally constant distance between the occupant's head and the headrest, the vehicle seat assembly of the present invention affords the seat occupant a greater level of safety in the event of a rear end collision. Whereas the distance between the head of a seat occupant and the headrest varies in conventional seat assemblies because of physiology and posture, the seat assembly of the present invention has a headrest which can “lean forward” as the seat occupant leans forward, and effectively shadow the seat occupant through various postures and positions. This ability provides a minimal, relatively consistent distance between the occupant's head and the headrest. During a rear end collision in a vehicle equipped with the vehicle seat assembly of the present invention, a seat occupant's head will travel only a minimal distance backwards before encountering the headrest. Similarly, the seat occupant's upper back and shoulders will also travel a correspondingly shorter distance before being “caught” by the upper back support member than would be the case in a conventional seat. In this manner, the vehicle seat assembly of the present invention can more quickly control the relative movement between an occupant's head, neck and shoulders during a rear end collision than a conventional vehicle seat assembly can.

Furthermore, by being configured to pivot toward the rearward end of the defined pivot range, the vehicle seat assembly can help to dissipate the impact forces acting on a seat occupant's body over a greater distance than would be the case with a conventional vehicle seat assembly. In some embodiments, the upper back support member may be constrained to pivot within a defined range that permits the headrest to move approximately 200 mm between the forward and the rearward ends. Such a configuration could provide approximately 200 mm within which to provide a relatively controlled deceleration of a seat occupant's head, neck and shoulders.

In other embodiments, the vehicle seat assembly may further include a damper connected to the upper back support member to slow its pivotal movement. The damper may comprise a gas damper, an hydraulic damper, or any other type of damper effective to slow the rate of pivotal movement of the upper back support member with respect to the lower back support member. In some embodiments, the damper may be a stand-alone component. In other embodiments, the damper may be integral with the spring such as, but not limited to, a gas spring having an integral damper. In some embodiments, the damper may comprise a cylinder having two chambers divided by a piston. A bore may be defined through the piston to permit fluid to pass between the chambers as the piston moves through the cylinder. The fluid may be either a liquid (i.e., an hydraulic damper) or a gas (i.e., a gas damper). Because the only route for the fluid to travel between the two chambers is the bore, the movement of the piston through the cylinder is necessarily slowed or cushioned as the fluid in one chamber passes through the bore.

In other embodiments, the vehicle seat assembly may further include a locking mechanism which permits a seat occupant to inhibit pivotal movement of the upper back support member with respect to the lower back support member. Such a locking mechanism would permit a seat occupant to adjust the upper back support member to a desired position and to retain it there similar to the way that conventional seat backs are pivotally adjusted with respect to a seat bottom. The locking mechanism may be a separate or stand alone component that is connected to the upper back support member, the lower back support member, the hinge, or to other pivot points connecting the upper and the lower back support members together. Any mechanism that is effective to inhibit pivotal movement of the upper back support member with respect to the lower back support member may be employed consistent with the principles and the teachings of the present invention.

In one embodiment, the locking mechanism may be integrated into the damper. For example, a valve may be positioned over the bore to selectively open and close the bore. When the valve closes the bore, fluid cannot pass between the two chambers of the damper thereby inhibiting movement of the upper back support member with respect to the lower back support member. A cable assembly may be connected to the valve to permit a seat occupant to remotely actuate the valve and thus control the locking and the unlocking of the locking mechanism. In some embodiments, the cable assembly may include a trigger or handle that can be mounted at any desirable location on the vehicle seat assembly, including the seat bottom. In embodiments of the vehicle seat assembly wherein the damper includes a valve and wherein the damper is filled with a gas, the upper back support can still provide pivotal movement to a seat occupant during a rear end collision when the damper has locked pivotal movement of the upper back support member. Because gases are compressible, the elevated forces exerted on the upper back support member by the upper body of an occupant can cause the gas in the locking mechanism/damper to compress when the valve is closed. This is referred to as a “spring locking” effect. The compression of the gas in the damper under the elevated forces exerted by the upper torso and head of an occupant during a rear end collision causes the upper back support member to pivot in a rearward direction during a collision and thus provide the benefit of absorbing the impact forces over a distance. A greater understanding of the embodiments of the invention disclosed herein may be gained through a review of the discussion below as well as the illustrations accompanying this disclosure.

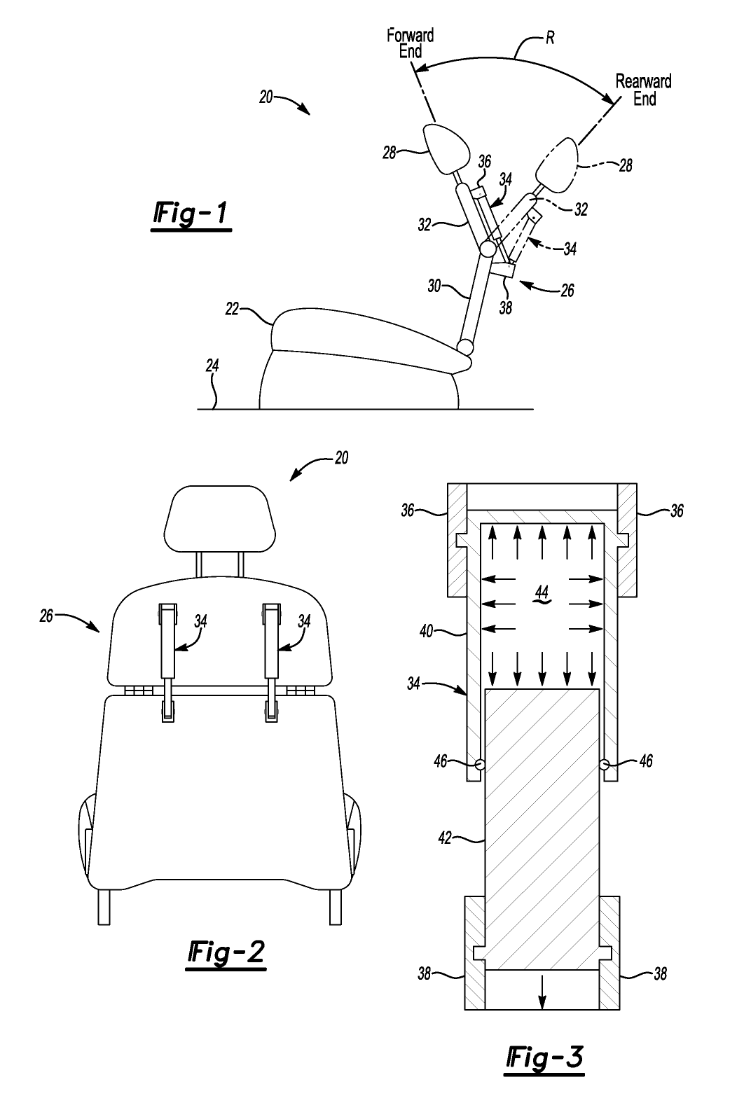

With respect to FIG. 1, a schematic view is presented illustrating an embodiment of the vehicle seat assembly 20 of the present invention. Vehicle seat assembly 20 includes a seat bottom 22 mounted to a floor surface of a vehicle. Seat bottom 22 may be mounted in any desirable manner including mounting in a fixed manner or in a manner configured to slide with respect to floor surface 24. Seat back assembly 26 is connected to seat bottom 22 at a bottom portion of seat back assembly 26. A headrest 28 is connected at an upper portion of seat back assembly 26. Seat back assembly 26 comprises a first or lower back support member 30 disposed adjacent seat bottom 22 and pivotally connected thereto. Seat back assembly 26 also includes a second or upper back support member 32 pivotally connected to lower back support member 30. Headrest 28 is attached to an upper portion of upper back support member 32. Upper back support member 32 is configured to pivot within a defined pivot range R having a forward end and a rearward end as indicated in FIG. 1.

Seat back assembly 26 further includes a biasing member 34 connected to both upper back support member 32 and lower back support member 30. Biasing member 34 is pivotally connected to upper back support member 32 through pivotal connector 36 and is pivotally connected to lower back support member 30 through pivotal connector 38. In other embodiments, the biasing member 34 may be connected to upper back support member 32 and to any other component such as, but not limited to, a floor, ceiling and/or pillar of the vehicle in which vehicle seat assembly 20 is mounted or to some other component of vehicle seat assembly 20. In the illustrated embodiment, biasing member 34 comprises a gas spring that biases upper back support member 32 towards the forward end of the defined pivot range. It should be understood that any suitable biasing member may be used for the purpose of biasing upper back support member 32 towards the forward end of the defined pivot range including, but not limited to, leaf springs, clock springs, coil springs, elastic materials and any other mechanism or member effective to urge upper back support member 32 towards the forward end. It should also be understood that biasing member 34, while illustrated in FIG. 1 as being external to seat back assembly 26, may be mounted integrally therewith and concealed from view by seat cushions, coverings and trim materials.

As illustrated in FIG. 1, upper back support member 32 rests at the forward end of the defined pivot range under the urging of biasing member 34 in the absence of any seat occupant sitting in vehicle seat assembly 20. Upper back support member 32 is also illustrated in phantom lines to indicate the rearward end of the defined pivot range.

With respect to FIG. 2, a rear view of vehicle seat assembly 20 is illustrated. As illustrated, seat back assembly 26 includes a pair of biasing members 34. In other embodiments, the vehicle seat assembly 20, a greater or lesser number of biasing members 34 may be employed.

FIG. 3 illustrates a schematic, cross-sectional view of an embodiment of biasing member 34. In the illustrated embodiment, biasing member 34 comprises a gas spring having a cylinder 40 and a piston 42. Cylinder 40 defines a cavity 44. Piston 42 is configured to slide into and out of cavity 44. A seal 46 creates an airtight fitting between piston 42 and cylinder 40. Seal 46 may comprise an O-ring or any other type of seal effective to create an airtight fitting. Cavity 44 contains a quantity of gaseous material at a pressure exceeding ambient atmospheric pressure. The gas in cavity 44 acts on piston 42 pushing it in an outward direction until a limiter (not shown) is reached. Configured in this manner, biasing means 34 acts to push upper back support member 32 towards the forward end of the defined pivot range. In one example, a gas spring having a spring constant of approximately 100 to 120 Newtons per meter has been found to be effective to support upper back support member 32. In another example, a gas spring having a spring constant of 110 Newtons per meter has been found to be effective to support upper back support member 32.

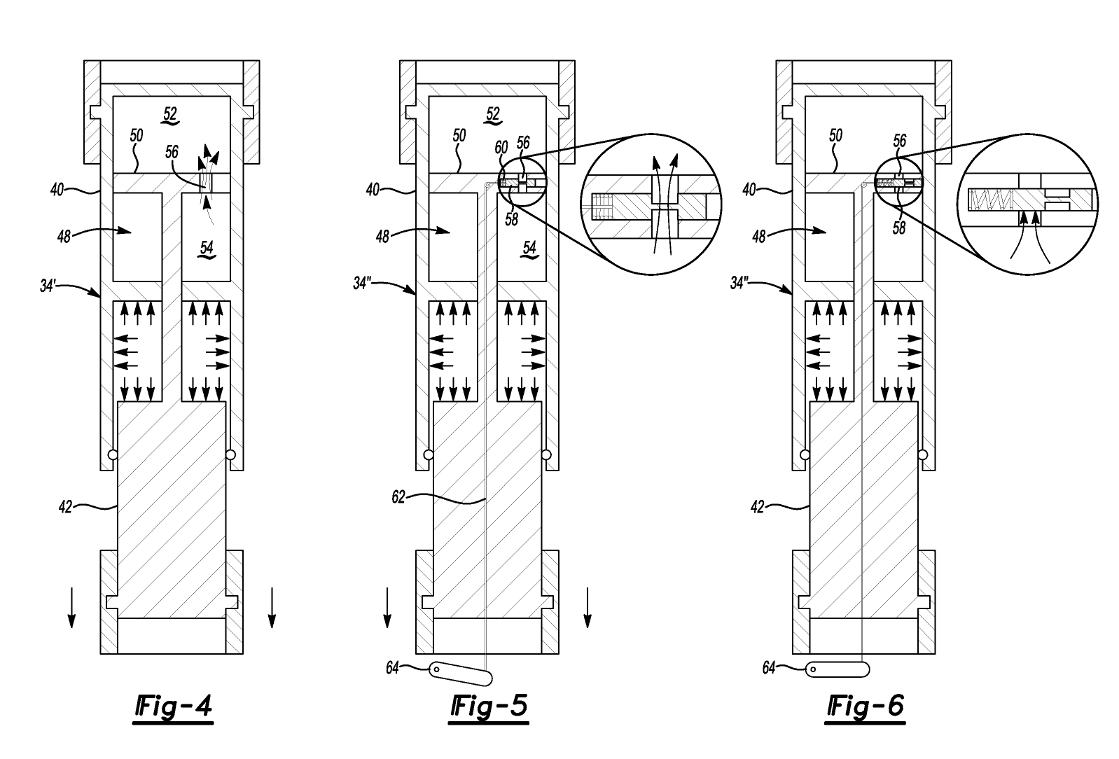

With respect to FIG. 4, biasing member 34′ is illustrated. This is an alternate embodiment of the gas spring depicted in FIG. 3 having an integral damper 48. Damper 48 comprises a portion of cylinder 40 and a secondary piston 50. Piston 50 divides the portion of cylinder 40 into a first chamber 52 and a second chamber 54. Secondary piston 50 defines a bore 56 extending through secondary piston 50 to connect first and second chambers 52, 54. Bore 56 permits fluid to move between first and second chambers 52, 54 as secondary piston 50 moves through cylinder 40. Bore 56 acts as a choke point that restricts the flow of fluid between first and second chambers 52, 54 and consequently slows the travel of secondary piston 50 through cylinder 40. As illustrated, secondary piston 50 is connected to piston 42. Consequently, the movement of piston 42 through cylinder 40 is correspondingly slowed as the fluid tries to pass through bore 56.

With respect to FIG. 5, biasing member 34″ is illustrated. Biasing member 34″ is a gas spring having an integral damper 48 and a valve 58 configured to selectively open and close bore 56. A spring 60 biases valve 58 towards a closed position. A cable 62 is connected to an end of valve 58 and is configured to pull valve 58 against spring 60 thereby moving valve 58 into the open position. Cable 62 is routed through sleeve 64 and is configured to slide therein permitting a user to remotely open and close valve 58.

With respect to FIG. 6, valve 58 is illustrated in the closed position. With valve 58 in the closed position, bore 56 is closed which, in turn, prevents fluid from moving between first and second chambers 52, 54. This, in turn, prevents secondary piston 50 from moving through cylinder 40. The inability of secondary piston 50 to move through cylinder 40 immobilizes piston 42. The immobilization of piston 42 prevents pivotal movement of upper back support member 32 with respect to lower back support member 30. In this manner, damper 48 and valve 58 together comprise a locking mechanism which permits a seat occupant to selectively lock upper back support member 32 at any desired position within the defined pivot range.

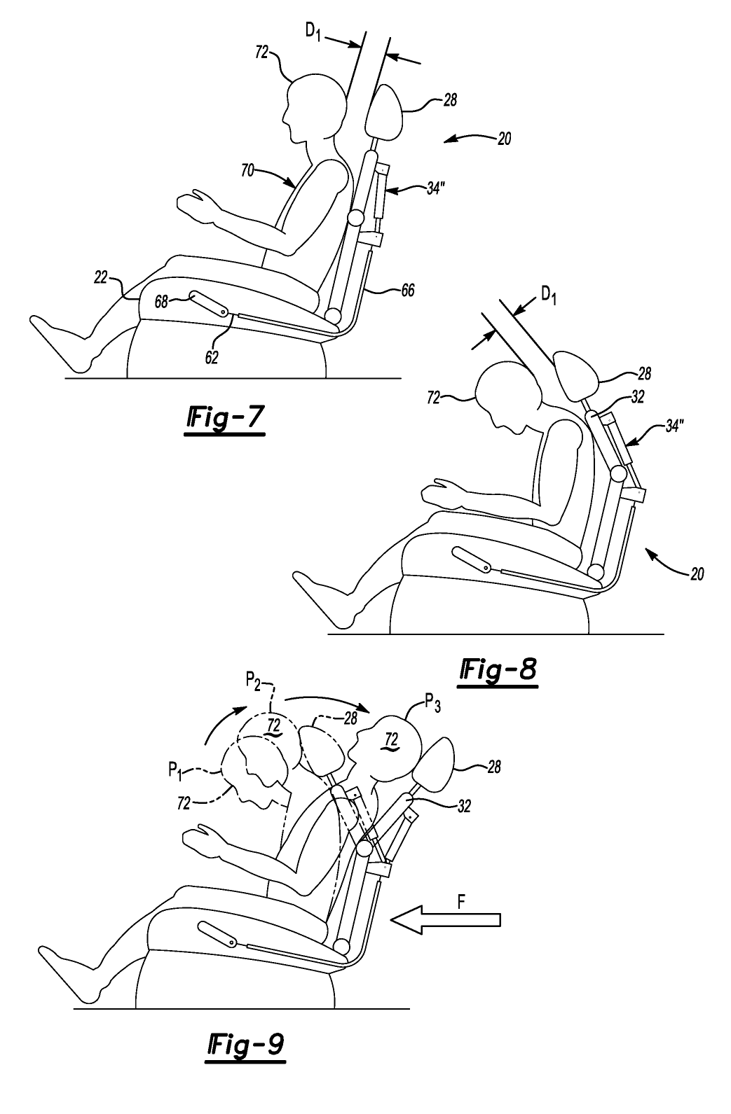

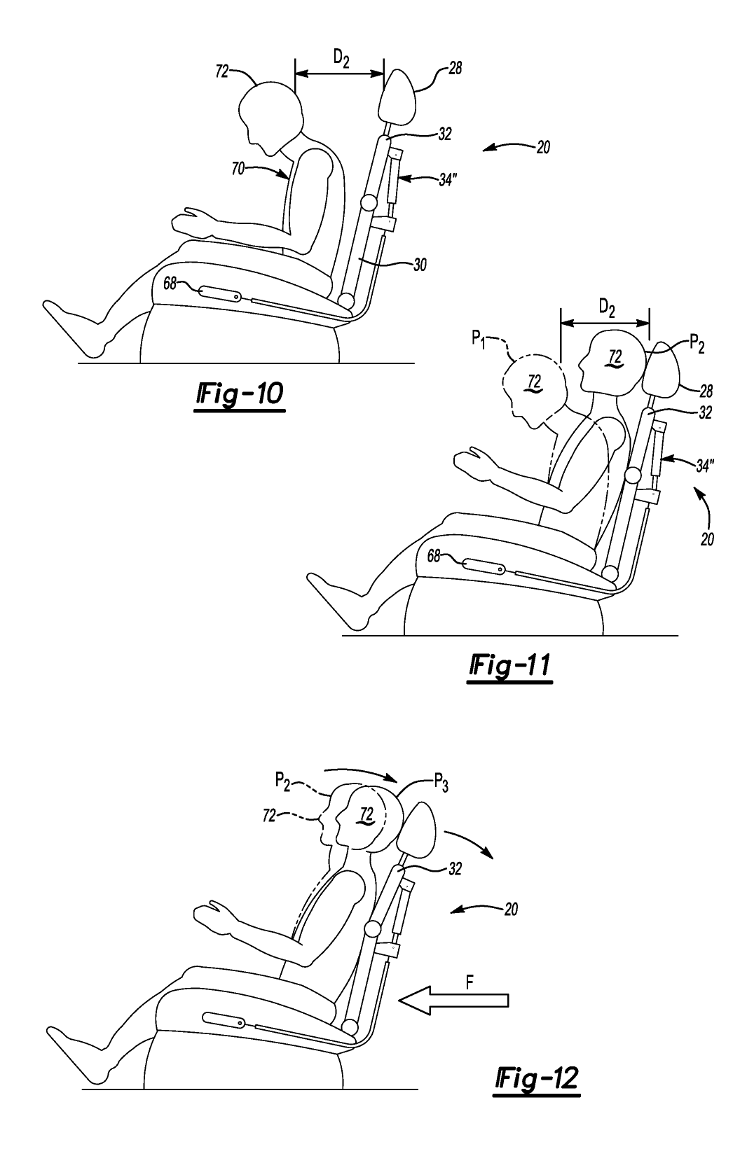

With respect to FIGS. 7 and 8, a vehicle seat assembly 20 equipped with biasing member 34″ is illustrated. A cable assembly 66, which may be a Bowden cable, connects valve 58 to trigger member 68, mounted on seat bottom 22. Trigger member 68 is configured to move between an upper position (see FIG. 7), and a lower position (see FIG. 10). When in the upper position, trigger member 68 places cable 62 in tension which, in turn, pulls valve 58 to the open position allowing fluid to move between the first and second chambers 52, 54 through bore 56. In FIG. 7, an occupant 70 is seated in a generally upright position in vehicle seat assembly 20. A distance D1 between occupant's head 72 and headrest 28 is indicated. As the occupant leans forward (as illustrated in FIG. 8), upper back support member 32 leans forward with him under the urging of biasing member 34″. Consequently, the distance between occupant's head 72 and headrest 28 remains generally constant at D1.

With respect to FIG. 9, occupant 70 and the vehicle seat assembly 20 illustrated in FIG. 8 is subjected to the impact force F that may accompany a rear end collision. P1 indicates the position of occupant's head 70 immediately prior to the impact. P2 illustrates the position of occupant's head 70 as it impacts headrest 28. Thus, occupant's head 72 has traveled a distance of D1 before being “caught” by headrest 28. P3 illustrates the position of occupant's head 72 when upper back support member 32 reaches the rear end of the defined pivot range. In this manner, the impact forces acting on occupant 70 and in particular occupant's head 72 and neck and shoulders is absorbed and dissipated over a period of time and through a defined distance, thus cushioning the impact forces and potentially reducing the likelihood of injury to occupant 70. It should be understood that the performance of vehicle seat assembly 20 illustrated in FIGS. 7-9 would similarly represent the performance of a vehicle seat assembly 20 equipped with biasing member 34′ having an integral damper but no locking mechanism.

With respect to FIG. 10, occupant 70 is seated in vehicle seat assembly 20 equipped with biasing member 34″ having the first and second chambers 52, 54 filled with a gas. Occupant 70 has placed trigger member 68 in the lowered position thus closing valve 58 and inhibiting upper back support member 32 from pivoting with respect to lower back support member 30. As contrasted with the illustration in FIG. 8, in FIG. 10, when occupant 70 leans forward, upper back support member 32 does not lean forward to follow occupant 70. Thus, the distance D2 between occupant's head 72 and headrest 28 varies with the position of occupant 70.

FIGS. 11 and 12 illustrate the effect of the impact forces of a rear end collision acting on the vehicle seat assembly 20 of FIG. 10. With respect to FIG. 11, P1 illustrates the position of occupant's head 72 immediately prior to a rear end collision. Occupant 70 is leaning forward and the distance between occupant's head 72 and headrest 28 is D2. Position P2 illustrates a position of occupant's head 72 after it has traveled distance D2 in response to impact force F acting on vehicle seat assembly 20. After traveling the distance D2, occupant's head 72 and shoulders impacts headrest 28 and upper back support member 32, respectively. Although trigger member 68 is in the lowered position and valve 58 is closed, because the first and second chambers 52, 54 are filled with a gas, and because gas is generally compressible, biasing member 34″ can “spring” backwards to soften the blow of the impact forces F acting on occupant 70's head 72 and shoulders where position P2 indicates the position of the occupant's head 72 when it first contacts headrest 28 and position P3 which represents the position of occupant's head 72 after upper back support member 32 has reached the end of its travel path permitted by the compressibility of gas contained within first and second chambers 52, 54.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle seat assembly comprising:
a first back support member configured for connection to a seat bottom;
a second back support member disposed above the first back support member and pivotally connected thereto, the second back support member being configured to receive a headrest; and
a first biasing member connected to the second back support member,
wherein the second back support member is configured to pivot with respect to the first back support member through a defined pivot range having a forward end and a rearward end, and wherein the first biasing member is configured to urge the second back support member towards the forward end of the defined pivot range.

2. The vehicle seat assembly of claim 1 wherein the first biasing member is further connected to the first back support member.

3. The vehicle seat assembly of claim 1 wherein the first biasing member comprises a gas spring.

4. The vehicle seat assembly of claim 1 wherein the first biasing member has a spring constant of between approximately 100 Newtons per meter and 120 Newtons per meter.

5. The vehicle seat assembly of claim 4 wherein the first biasing member has a spring constant of approximately 110 Newtons per meter.

6. The vehicle seat assembly of claim 1 further comprising a second biasing member connected to the second back support member, the second biasing member being configured to urge the second back support towards the forward end of the defined pivot range.

7. The vehicle seat assembly of claim 1 further comprising a damper configured to dampen pivotal motion of the second back support member as the second back support member pivots through the defined pivot range.

8. The vehicle seat assembly of claim 7 wherein the first biasing member is a gas spring having an integral damper.

9. The vehicle seat assembly of claim 7 wherein the damper comprises an hydraulic damper.

10. The vehicle seat assembly of claim 1 wherein the second back support member is configured to move the headrest approximately 200 mm as the second back support member pivots between the rearward end and the forward end of the defined sweep range.

11. A vehicle seat assembly comprising:
a first back support member configured for connection to a seat bottom;
a second back support member disposed above the first back support member and pivotally connected thereto, the second back support member being configured to receive a headrest;
a first biasing member connected to the second back support member; and
a locking mechanism connected to the second back support member, the locking mechanism being configured to move between a locked position and an unlocked position,
wherein the second back support member is configured to pivot with respect to the first back support member through a defined pivot range having a forward end and a rearward end, wherein the first biasing member is configured to urge the second back support member towards the forward end of the defined pivot range, and wherein the locking mechanism is configured to inhibit pivotal movement of the second back support member with respect to the first back support member when the locking mechanism is in the locked position.

12. The vehicle seat assembly of claim 11 wherein the locking mechanism is configured to permit the second back support member to pivot with respect to the first back support member when forces acting on the second back support member exceed a predetermined threshold.

13. The vehicle seat assembly of claim 11 wherein the first biasing member is integral with the locking mechanism.

14. The vehicle seat assembly of claim 11 wherein the locking mechanism comprises:
a cylinder having a first chamber and a second chamber;
a piston separating the first chamber from the second chamber, the piston defining a bore extending therethrough to permit a fluid to pass between the first chamber and the second chamber as the piston moves through the cylinder; and
a valve connected to the piston configured to selectively open and close the bore.

15. The vehicle seat assembly of claim 14 further comprising a cable assembly connected to the locking mechanism and a trigger member connected to the cable assembly, the trigger member being configured to remotely actuate the locking mechanism via the cable assembly.

16. The vehicle seat assembly of claim 15 wherein the trigger member is configured for attachment to the seat bottom.

17. The vehicle seat assembly of claim 11 wherein the locking mechanism is configured to move to the locked position while the second back support member is disposed at any desired position within the defined pivot range.

18. The vehicle seat assembly of claim 11 wherein the first biasing member comprises a gas spring.

19. The vehicle seat assembly of claim 18 wherein the gas spring has an integral hydraulic damper.

20. A vehicle seat assembly comprising:
a seat bottom configured for attachment to a vehicle;
a first back support member pivotally connected to the seat bottom;
a second back support member disposed above the first back support member and being pivotally connected thereto;
a headrest connected to the second back support member;
a gas spring connected to the first back support member and the second back support member, the gas spring having an integral damper and an integral locking mechanism configured to move between a locked position and an unlocked position,
wherein the second back support member is configured to pivot with respect to the first back support member through a defined pivot range having a forward end and a rearward end, wherein the gas spring is configured to urge the second back support member towards the forward end of the defined pivot range, wherein the integral damper is configured to dampen pivotal movement of the second back support member as the second back support member pivots through the defined pivot range and wherein the integral locking mechanism is configured to inhibit pivotal movement of the second back support member with respect to the first back support member when the locking mechanism is in the locked position.
